(19) United States
(12) Patent Application Publication
(10) Pub. No.: US 2019/0061239 A1
(43) Pub. Date: Feb. 28, 2019

(54) NOVEL SEPARABLE 3D PRINTER

(71) Applicant: Huilin LIU, Guangdong (CN)

(72) Inventor: Huilin LIU, Guangdong (CN)

(21) Appl. No.: 15/822,213

(22) Filed: Nov. 27, 2017

(30) Foreign Application Priority Data
Aug. 22, 2017 (CN) 201721050315.2

(51) Int. Cl. B29C 64/20; B29C 64/393; B33Y 30/00

(52) U.S. Cl. CPC B29C 64/20; B33Y 30/00; B29C 64/393

(57) ABSTRACT

The utility model discloses a novel separable 3D printer. The novel separable 3D printer comprises an electric control assembly and a mechanical printing assembly, wherein the electric control assembly and the mechanical printing assembly are of a separated structure and are electrically connected through aviation joints. The electric control assembly and the mechanical printing assembly are of the separated structure and are electrically connected through the aviation joints, so that the separable 3D printer is obtained, and the problems in the prior art that an integrated 3D printer is inconvenient to transport and repair later, and the size of the integrated 3D printer cannot be expanded conveniently are solved.

### BACKGROUND OF THE INVENTION

The utility model relates to the technical field of 3D printers, in particular to a novel separable 3D printer.

An existing 3D printer based on the FDM hot-melting technique on the market is mainly of an integrated structure provided with a box-type shell or a frame made of profiles, the electric control part and the mechanical structure part of the existing 3D printers is integrally assembled, the whole printer needs to be returned to the factory to be repaired under the condition that the printer cannot be maintained by a customer, and the integrated large-sized 3D printer needs to be returned to the factory completely, thereby being inconvenient to transport, repair and maintain later after sale; meanwhile, the integrated 3D printer cannot be conveniently upgraded into a 3D printer with a larger print size by expanding the function and the size due to structural characteristic limitations, a user needs to purchase a large-sized 3D printer, and the price of the large-sized printer is extremely high.

### BRIEF SUMMARY OF THE INVENTION

The utility model provides a novel separable 3D printer which solves the problems that an integrated 3D printer in the prior art is inconvenient to transport and repair later, and the size of the integrated 3D printer cannot be expanded conveniently.

According to the technical scheme of the utility model:

A novel separable 3D printer comprises an electric control assembly and a mechanical printing assembly, wherein the electric control assembly and the mechanical printing assembly are of a separated structure and electrically connected through aviation joints.

Furthermore, the mechanical printing assembly comprises a mechanical profile support, an X-axis/Z-axis movement assembly and a Y-axis movement assembly, wherein the mechanical profile support comprises a horizontal support and a vertical support, the horizontal support is perpendicular to the vertical support, the Y-axis movement assembly is fixed to the horizontal support, and the X-axis/Z-axis movement assembly is fixed to the vertical support.

Furthermore, both the horizontal support and the vertical support are made of V-shaped profiles, and the horizontal support and the vertical support are fixedly connected through a plurality of bolts at the joints.

Furthermore, the number of the bolts is four.

Furthermore, a Y-axis movement guide rail is mounted on the horizontal support, V-shaped grooves are formed in the side faces of the Y-axis guide rail, the Y-axis movement assembly is provided with V-shaped sliding wheels and a Y-axis driving motor, and the Y-axis driving motor drives the V-shaped sliding wheels to move in the V-shaped grooves of the Y-axis guide rail.

Furthermore, the X-axis/Z-axis movement assembly comprises an X-axis driving motor, a Z-axis driving motor, a printing spray head and a horizontal V-shaped guide rail, wherein the X-axis driving motor is mounted on the horizontal V-shaped sliding rail through a connecting plate, the printing spray head is fixed to a printing head fixing seat, three V-shaped sliding wheels are mounted on the printing head fixing seat and clamp the horizontal V-shaped guide rail in a triangular mode, the two ends of the horizontal guide rail are provided with at least three V-shaped sliding wheels and connected to the vertical support in an assembled mode, and the Z-axis driving motor drives the horizontal V-shaped sliding rail to slide on the vertical support in the vertical direction.

The novel separable 3D printer of the utility model has the beneficial effects that the electric control assembly and the mechanical printing assembly are of the separated structure and are electrically connected through the aviation joints, so that the separable 3D printer is obtained, and the problems in the prior art that an integrated 3D printer is inconvenient to transport and repair later, and the size of the integrated 3D printer cannot be expanded conveniently are solved.

### BRIEF DESCRIPTION OF THE DRAWINGS

For a clearer description of the technical scheme of the embodiments of the utility model or the technical scheme of the prior art, the drawings required for describing the embodiments or the prior art are illustrated briefly as follows, obviously, the drawings in the following description only refer to certain embodiments of the utility model, and for those skilled in the field, other drawings can also be obtained without creative work according to the drawings.

FIG. 1 is a top view of one embodiment of a novel separable 3D printer of the utility model;

FIG. 2 is a front view of one embodiment of the novel separable 3D printer of the utility model;

FIG. 3 is a lateral view of a mechanical printing assembly;

FIG. 4 is a lateral view of an electric control assembly.

In the FIGs, 1—electric control assembly; 2—mechanical printing assembly; 3—aviation joint; 4—mechanical support; 401—horizontal support; 402—vertical support; 5—X-axis/Z-axis movement assembly; 501—X-axis driving motor; 502—Z-axis driving motor; 503—horizontal sliding rail; 6—Y-axis movement assembly; 601—sliding wheel.

### DETAILED DESCRIPTION OF THE INVENTION

A clear and complete description of the technical scheme of the embodiments of the utility model is given with the accompanying drawings in the embodiment of the utility model as follows, and obviously, the embodiments in the description are only part of embodiments of the utility model instead of all embodiments of the utility mode. Based on the embodiments in the utility model, all other embodiments obtained by those skilled in the field without creative work are within the protection scope of the utility model.

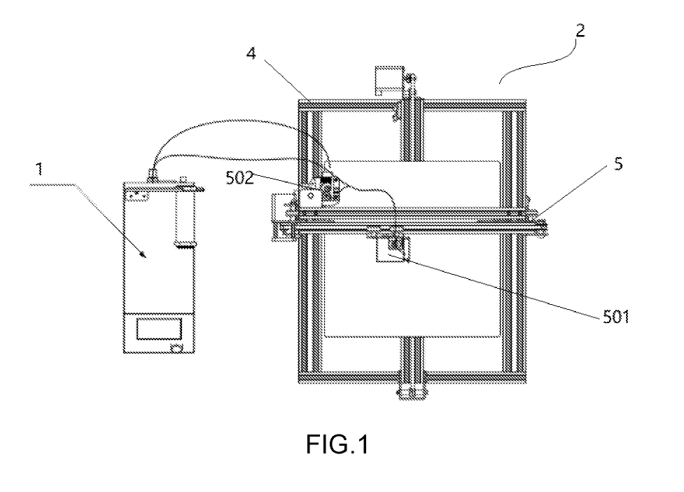

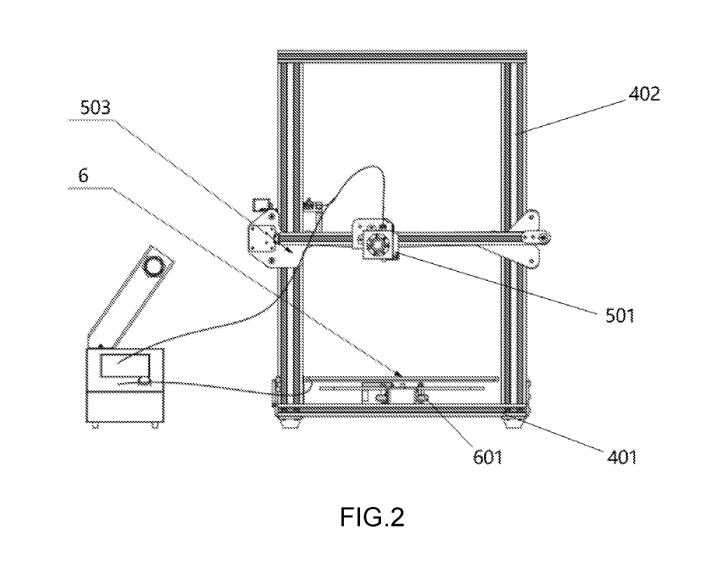

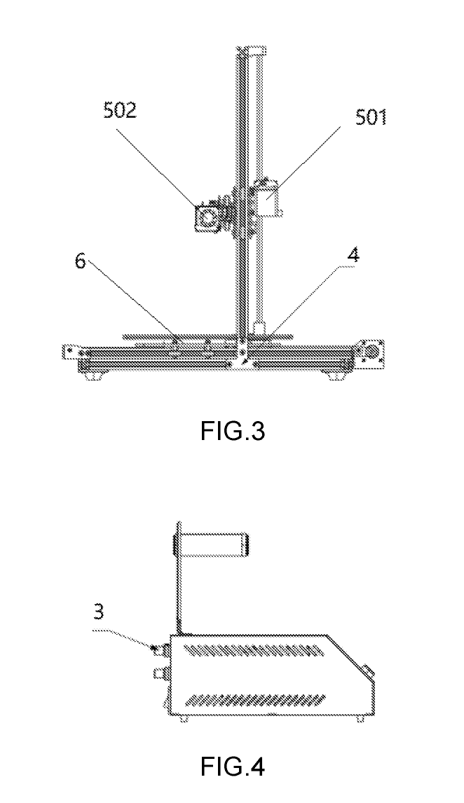

As is shown in FIGS. 1-4, the utility model provides a novel separable 3D printer which comprises an electric control assembly 1 and a mechanical printing assembly 2, wherein the electric control assembly 1 and the mechanical printing assembly 2 are of a separated structure and are electrically connected through aviation joints 3.

The electric control assembly 1 and the mechanical printing assembly 2 are electrically connected through the aviation joints 3 and can be connected rapidly and reliably to work cooperatively; if the novel separable 3D printer needs to be expanded into 3D printers of other specifications and sizes, only components of the mechanical structure part need to be replaced, the novel separable 3D printer can be upgraded and expanded extremely conveniently, and the cost is greatly reduced.

The electric control assembly 1 and the mechanical printing assembly 2 of the utility model are of the separated structure and are electrically connected through the aviation joints, so that the separable 3D printer is obtained, and the problems in the prior art that an integrated 3D printer is inconvenient to transport and repair later, and the size of the integrated 3D printer cannot be expanded conveniently are solved.

The electric control assembly 1 can be manufactured through the electric control technique for the 3D printers in the prior art.

The mechanical printing assembly 2 comprises a mechanical support 4, an X-axis/Z-axis movement assembly 5 and a Y-axis movement assembly 6, the mechanical support 4 comprises a horizontal support 401 and a vertical support 402, the horizontal support 401 is perpendicular to the vertical support 402, the Y-axis movement assembly 6 is fixed to the horizontal support 401, and the X-axis/Z-axis movement assembly 5 is fixed to the vertical support 402. Specifically, the electric control assembly 1 is electrically connected with the X-axis/Z-axis movement assembly 5 and the Y-axis movement assembly 6 through the aviation joints respectively.

Both the horizontal support 401 and the vertical support 402 are made of V-shaped profiles, and the horizontal support 401 and the vertical support 402 are fixedly connected through a plurality of bolts at the joints. The print size of the 3D printer can be expanded by changing the sizes and lengths of the V-shaped profiles.

The number of the bolts is four.

The horizontal support 401 is provided with a protruding part, and sliding grooves are formed in the two sides of the protruding part; the Y-axis movement assembly 6 is provided with sliding wheels 601 and a Y-axis driving motor (not shown in FIGs), and the Y-axis driving motor drives the sliding wheels 601 to slide in the sliding grooves. The upper surface of the Y-axis movement assembly 6 is fixedly connected with a printing forming platform.

The X-axis/Z-axis movement assembly 5 comprises an X-axis driving motor 501, a Z-axis driving motor 502, a printing spray head (not shown in FIGs) and a horizontal sliding rail 503, wherein the X-axis driving motor 501 is connected with the horizontal sliding rail 503 in a clamped mode, the printing spray head is fixed to the X-axis driving motor 501, and the two ends of the horizontal sliding rail 503 are connected with the vertical support 402 in a clamped mode, and the Z-axis driving motor 502 drives the horizontal sliding rail 503 to slide on the vertical support 402 in the vertical direction.

The mechanical printing assembly 2 comprises a traditional X-axis coordinate structure, a traditional Y-axis coordinate structure and a traditional Z-axis coordinate structure; in the transportation and delivery process, the X-axis coordinate structure and the Z-axis coordinate structure can be separated to be folded and packed, so that the transportation size and the transpiration cost are greatly reduced, and a great technical cost advantage is achieved particularly for the international trade market.

The improvement of the technical scheme of the utility model is disclosed, and those skilled in the field can refer to existing techniques for technical contents which are not described in detail.

The foregoing description only refers to preferred embodiments of the utility model and is not used for limiting the utility model, and any modifications, equivalent substitutes, and improvements which are made based on the spirit and principle of the utility model all should be within the protection scope of the utility model.

What is claimed is:

1. A novel separable 3D printer, characterized by comprising an electric control assembly and a mechanical printing assembly, wherein the electric control assembly and the mechanical printing assembly are of a separated structure and are electrically connected through aviation joints.

2. The novel separable 3D printer according to claim 1, characterized in that the mechanical printing assembly comprises a mechanical profile support, an X-axis/Z-axis movement assembly, and a Y-axis movement assembly, wherein the mechanical profile support comprises a horizontal profile support and a vertical profile support, the horizontal support is perpendicular to the vertical portal support, the Y-axis movement assembly is fixed to the horizontal support, and the X-axis/Z-axis movement assembly is fixed to the vertical portal support.

3. The novel separable 3D printer according to claim 2, characterized in that both the horizontal support and the vertical portal support are made of V-shaped profiles, and the horizontal support and the vertical portal support are fixedly connected through a plurality of bolts at the joints.

4. The novel separable 3D printer according to claim 3, characterized in that the number of the bolts is four.

5. The novel separable 3D printer according to claim 3, characterized in that a Y-axis movement guide rail is mounted on the horizontal support, V-shaped grooves are formed in the side faces of the Y-axis guide rail, the Y-axis movement assembly is provided with V-shaped sliding wheels and a Y-axis driving motor, and the Y-axis driving motor drives the V-shaped sliding wheels to move in the V-shaped grooves of the Y-axis guide rail.

6. The novel separable 3D printer according to claim 3, characterized in that the X-axis/Z-axis movement assembly comprises an X-axis driving motor, a Z-axis driving motor, a printing spray head and a horizontal V-shaped guide rail, wherein the X-axis driving motor is mounted on the horizontal V-shaped sliding rail through a connecting plate, the printing spray head is fixed to a printing head fixing seat, three V-shaped sliding wheels are mounted on the printing head fixing seat and clamp the horizontal V-shaped guide rail in a triangular mode, the two ends of the horizontal guide rail are provided with at least three V-shaped sliding wheels and connected to the vertical support in an assembled mode, and the Z-axis driving motor drives the horizontal V-shaped sliding rail to slide on the vertical support in the vertical direction.
